(19) United States
(12) Patent Application Publication
(10) Pub. No.: US 2024/0219521 A1
(43) Pub. Date: Jul. 4, 2024

(54) OBJECT RECOGNITION DEVICE

(71) Applicant: DENSO CORPORATION, Kariya-city (JP)

(72) Inventors: Shingo SHIMIZU, Nisshin-city (JP); Tetsuya KUSUMOTO, Nisshin-city (JP); Masaki YONEDA, Kariya-city (JP); Takashi OGAWA, Kariya-city (JP)

(21) Appl. No.: 18/604,161

(22) Filed: Mar. 13, 2024

Related U.S. Application Data
(63) Continuation of application No. PCT/JP2022/034198, filed on Sep. 13, 2022.

(30) Foreign Application Priority Data
Sep. 15, 2021 (JP) 2021-150255

(51) Int. Cl. G01S 7/41; G01S 13/931

(52) U.S. Cl. CPC G01S 7/412; G01S 13/931; G01S 2013/9323

(57) ABSTRACT

An object recognition device according to one aspect of the present disclosure includes a target sensor, a tracking unit, a detection probability calculation unit, a presence probability calculation unit, and a recognition unit. The detection probability calculation unit is configured to calculate a detection probability of a target in the current process cycle, wherein the stronger the reflection intensity in the previous processing cycle, the higher is made the calculated detection probability. The presence probability calculation unit is configured to calculate the presence probability of the target with respect to the observed value of the reflection position in the current processing cycle, using the calculated detection probability. The recognition unit is configured to recognize a target being tracked as a target representing an object, in response to the presence probability being greater than or equal to a predetermined value.

### CROSS-REFERENCE TO RELATED APPLICATION

The present application is a continuation application of International Application No. PCT/JP2022/034198, filed on Sep. 13, 2022, which claims priority to Japanese Patent Application No. 2021-150255, filed on Sep. 15, 2021. The contents of these applications are incorporated herein by reference in their entirety.

### BACKGROUND

### Technical Field

The present disclosure relates to an object recognition device.

### Background Art

With the target detection device, a reflection point that is detected continuously for a prescribed period is recognized as an object, whereas a reflection point that is not detected continuously for the prescribed period is judged to be floating matter such as fog or exhaust gas.

### SUMMARY

In the present disclosure, provided is an object recognition device as the following.

The object recognition device includes a target sensor, a tracking unit, a detection probability calculation unit, a presence probability calculation unit, and a recognition unit. The detection probability calculation unit is configured to calculate a detection probability of a target in the current process cycle, wherein the stronger the reflection intensity in the previous processing cycle, the higher is made the calculated detection probability. The presence probability calculation unit is configured to calculate the presence probability of the target with respect to the observed value of the reflection position in the current processing cycle, using the calculated detection probability. The recognition unit is configured to recognize a target being tracked as a target representing an object, in response to the presence probability being greater than or equal to a predetermined value.

### BRIEF DESCRIPTION OF THE DRAWINGS

FIG. 1 is a block diagram showing a schematic configuration of an object recognition device according to a first embodiment.

FIG. 2 is a flowchart showing an object recognition processing procedure according to the first embodiment.

FIG. 3 is a diagram showing a reflection intensity distribution for calculating a detection probability distribution according to the first embodiment.

FIG. 4 is a flowchart showing an object recognition processing procedure according to a second embodiment.

FIG. 5 is a flowchart showing an object recognition processing procedure according to a third embodiment.

FIG. 6 is a flowchart showing an object recognition processing procedure according to a fourth embodiment.

FIG. 7 is a flowchart showing an object recognition processing procedure according to a fifth embodiment.

FIG. 8 is a flowchart showing an object recognition processing procedure according to a sixth embodiment.

### DETAILED DESCRIPTION OF THE PREFERRED EMBODIMENTS

With the target detection device described in patent document PTL1 below, a reflection point that is detected continuously for a prescribed period is recognized as an object, whereas a reflection point that is not detected continuously for the prescribed period is judged to be floating matter such as fog or exhaust gas.
[PTL 1] Japanese Patent Publication No. 2014-92434

Since the reflected signal from a distant object is weak, the detection of the distant object becomes unstable, and it is difficult to detect the distant object continuously for a prescribed period. As a result of detailed studies by the inventors, it has been found that the above-described target detection device exhibits a delay in recognizing an object that is distant.

From one aspect of the present disclosure, it is desirable to be able to quickly recognize an object based on a weak reflected signal, while suppressing erroneous recognition of noise as being an object.

An object recognition device according to one aspect of the present disclosure includes a target sensor, a tracking unit, a detection probability calculation unit, a presence probability calculation unit, and a recognition unit. The target sensor is configured to transmit a probe wave to the surroundings, receive a reflected wave produced by reflection of the probe wave from a target, and, based on the received reflected wave, periodically and repeatedly acquire an observed value of the reflection position and an observed value of the reflection intensity. The tracking unit is configured to sequentially estimate a state quantity of the target in the current processing cycle based on (i) the observed value of the reflected position obtained by the target sensor and (ii) a state quantity of the target which includes at least the reflection position and is estimated in the previous processing cycle, and track the target. The detection probability calculation unit is configured to calculate a detection probability of the target in the current processing cycle based on the observed value of the reflection intensity acquired in the previous processing cycle or on the reflection intensity included in the state quantity of the target. The detection probability calculation unit is configured to calculate a higher detection probability in accordance with increase of the reflection intensity. The presence probability calculation unit is configured to calculate the presence probability of the target with respect to the observed value of the reflection position in the current processing cycle, using the detection probability calculated by the detection probability calculation unit. The recognition unit is configured to recognize a target being tracked by the tracking unit as a target representing an object, in response to the presence probability calculated by the presence probability calculation unit being greater than or equal to a predetermined value.

It has been found that thermal noise has a major effect in determining whether a target is detected. Hence, it has been found that a correlation can be formulated between (i) the reflection intensity and (ii) the probability of detection (that is, the detection probability) when a target is present at the reflection position. Thus, an object recognition device according to one aspect of the present disclosure calculates detection probability in accordance with reflection intensity. The probability that a target is present at the reflection position (that is, the presence probability) is then calculated using the detection probability, and if the presence probability is equal to or greater than a predetermined value, a target being tracked is recognized. It is thereby possible to quickly recognize a target representing an object based on a weak reflected signal, while suppressing erroneous recognition of noise as being an object.

Embodiments of the present disclosure are described below with reference to the drawings.

### 1. First Embodiment

### 1-1. Configuration

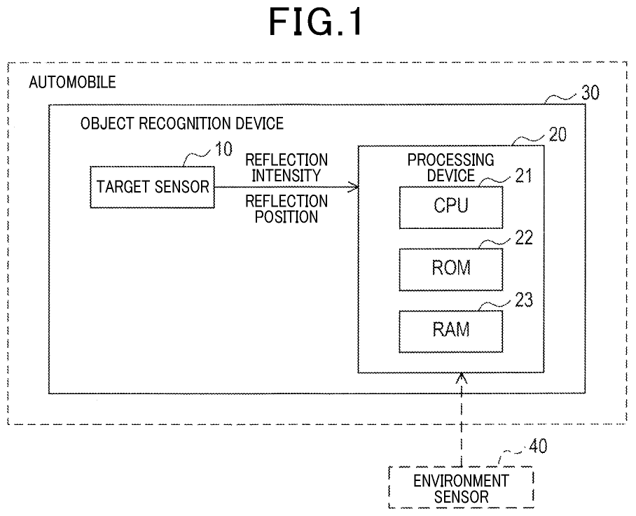

The configuration of an object recognition device 30 according to this embodiment will be described with reference to FIG. 1.

The object recognition device 30 has a target sensor 10 and a processing device 20. The object recognition device 30 of this embodiment is mounted to an automobile.

The target sensor 10 periodically and repetitively transmits probe waves to a surrounding area and receives reflected waves produced by reflection of the probe waves from a target. Based on the received reflected waves, the target sensor 10 periodically and repetitively obtains the reflection position of the reflected waves (that is, the position of the target) and the reflection intensity of the reflected waves. The target sensor 10 is mounted, for example, in the center of the front bumper of the automobile. In this embodiment, a physical quantity acquired by the target sensor 10 is called an observed value.

The target sensor 10 of this embodiment is a laser radar apparatus that emits laser light as probe waves. It should be noted that the target sensor 10 is not limited to being a laser radar apparatus, and may be a millimeter wave radar apparatus that emits millimeter waves as probe waves. Alternatively, the target sensor may be a radar apparatus that emits electromagnetic waves as probe waves.

The processing device 20 is connected to the target sensor 10, and tracks and recognizes a target based on at least one observed value obtained by the target sensor 10. The processing device 20 includes a CPU 21, a ROM 22, and a RAM 23. The CPU 21 executes programs stored in the ROM 22 to implement the functions of a tracking unit, a detection probability calculation unit, a presence probability calculation unit, and a recognition unit.

The tracking unit tracks a target detected by the target sensor 10. Specifically, the tracking unit associates (i) an observed value of the target in the current processing cycle and (ii) a state quantity of the target obtained in the previous processing cycle, and sequentially estimates the state quantity of the target in the current processing cycle from the associated observed value of the target and state quantity of the target. A state quantity is a physical quantity that is estimated from an observed value. Specifically, a state quantity in the current processing cycle is estimated from an observed value obtained in the previous processing cycle and a state quantity estimated in the previous processing cycle. The tracking unit associates an observed value of a target with the state quantity of the target which is most relevant to that observed value.

In addition to reflection points of objects, reflection points that reflect probe waves occur in suspended matter (i.e., noise) such as fog and exhaust gas. Here, the term “objects” signifies three-dimensional objects such as preceding vehicles, side walls, guardrails, fallen objects, and pedestrians. The processing device 20 removes the noise from the reflection points detected by the target sensor 10, and recognizes a reflection point indicating an object as a target.

The detection probability calculation unit calculates the detection probability P_{d} of a target in the current processing cycle, based on the observed value of reflection intensity of the target acquired in the previous processing cycle or on the state quantity of that reflection intensity. The detection probability P_{d} corresponds to the probability that a target is detected.

In the current processing cycle, the presence probability calculation unit uses the calculated detection probability P_{d} to calculate a presence probability Vₖ of a target for each of respective observed values of reflection positions. The presence probability Vₖ corresponds to the probability that a target is present at the reflection position having the observed value.

If the calculated presence probability Vₖ is equal to or greater than a probability threshold value, the recognition unit recognizes a target being tracked. That is, if the presence probability Vₖ is equal to or greater than the probability threshold value, the recognition unit recognizes the target being tracked as being an object such as a preceding vehicle, and not floating matter (that is, noise) such as fog or exhaust gas.

### 1-2. Processing

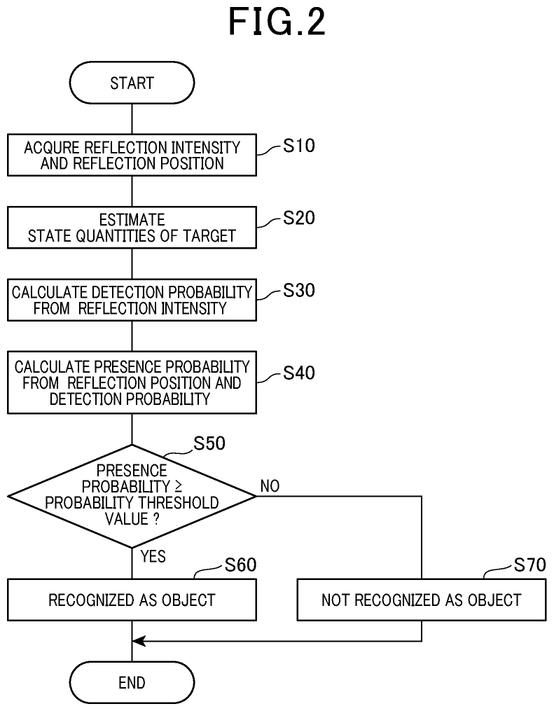

Object recognition processing executed by various functions of the processing device 20 will next be described with reference to the flowchart of FIG. 2.

In S10 the tracking unit acquires, from the target sensor 10, observed values of reflection intensity and reflection position for each of respective reflection points. Each reflection point is regarded as a pre-recognition target. Pre-recognition targets include noise such as floating matter, in addition to targets indicating objects.

Next, in S20, the tracking unit estimates the state quantities of the targets. That is, for each of the targets, the tracking unit associates the observed values acquired for that target in the current processing cycle with the state quantities which, among the state quantities estimated in the previous processing cycle, are highly relevant to these observed values. The tracking unit then applies a Kalman filter or the like to the associated observed values and state quantities of a target, for estimating the state quantities of the target in the current processing cycle. The observed values and state quantities of a target include at least the reflection position, and may also include the reflection intensity in addition to the reflection position.

Subsequently, in S30, the detection probability calculation unit calculates a target detection probability P_{d} for each of the targets in the current processing cycle, from the observed values of reflection intensity acquired in the previous processing cycle. As a result of study by the inventors, it has been found that thermal noise has a major effect in determining whether a target is detected, and that a correlation between reflection intensity and detection probability can be formulated.

For example, when an object such as a preceding vehicle is near the target sensor 10, the reflection intensity of the object becomes relatively strong, and the object tends to be continuously detected. On the other hand, when an object such as a preceding vehicle is distant from the target sensor 10, the reflection intensity of the object is relatively weak, and noise such as thermal noise makes it difficult to continuously detect the object.

Hence, the detection probability calculation unit formulates a correlation between the reflection intensity and the detection probability P_{d}. Specifically, the greater the reflection intensity in the previous processing cycle, the higher is the detection probability P_{d} that is calculated by the detection probability calculation unit.

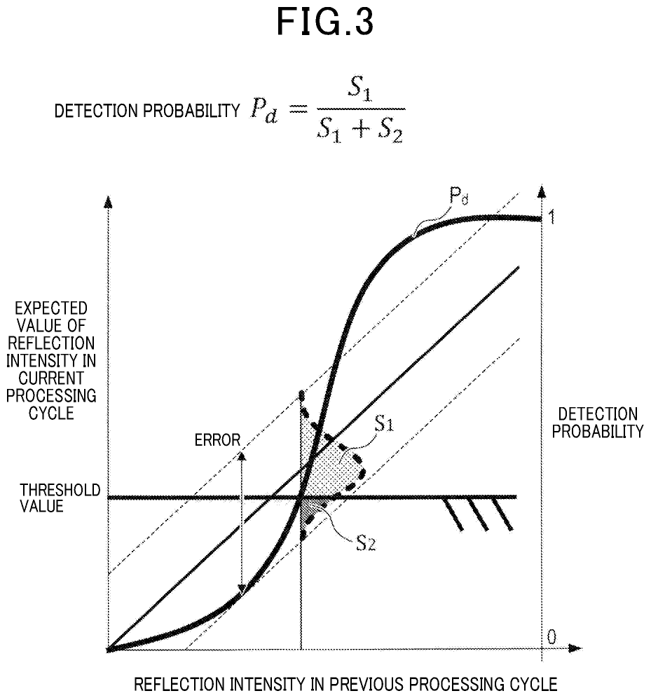

The detection probability calculation unit approximates the reflection intensity distribution to a Gaussian distribution. Specifically, as shown in FIG. 3, the detection probability calculation unit uses the value of reflection intensity obtained in the previous processing cycle as the expected value of reflection intensity in the current processing cycle. Furthermore, the detection probability calculation unit sets a prescribed error range around the expected value, in the reflection intensity distribution. That is, the approximated Gaussian distribution has a spread that is within a prescribed error range, with the expected value as the median value.

The detection probability calculation unit then calculates the detection probability, based on the proportion of intensity values that exceed a prescribed intensity threshold in the Gaussian distribution. That is, the detection probability calculation unit calculates the detection probability P_{d} based on a first area S1 and second area S2 in the Gaussian distribution. The first area S1 corresponds to the area in which values that are equal to or greater than the intensity threshold are distributed in the Gaussian distribution. The second area S2 corresponds to the area in which values that are less than the intensity threshold are distributed in the Gaussian distribution. The intensity threshold value serves for detecting the reflection intensity of a target separately from the reflection intensity of noise, such as thermal noise. The detection probability P_{d} is calculated from the equation:

$${P}_{d} = S 1 / ( S 1 + S 2 ) .$$

It should be noted that the detection probability calculation unit may calculate the detection probability P_{d} using the state quantity of the reflection intensity estimated in the previous processing cycle, instead of the observed value of the reflection intensity acquired in the previous processing cycle. In that case, the greater the state quantity of the reflection intensity in the previous processing cycle, the higher is the detection probability P_{d} that is calculated by the detection probability calculation unit.

Moreover, the detection probability calculation unit may approximate the distribution of the reflection intensity by using a distribution other than a Gaussian distribution, such as a Rayleigh distribution. Alternatively, the detection probability calculation unit may calculate the detection probability P_{d} without using a reflection intensity distribution. For example, an equation expressing the relationship between the reflection intensity and the detection probability P_{d} may be derived, and used for calculating the detection probability P_{d}. Furthermore, the detection probability calculation unit may prepare beforehand a correspondence table between the detection probability P_{d} and the reflection intensity, and calculate the detection probability P_{d} using the prepared correspondence table.

Next, in S40, using the detection probability P_{d} obtained in the current processing cycle, calculated in S30 for each target, the presence probability calculation unit calculates the presence probability Vₖ of the object corresponding to the observed value of the reflection position in the current processing cycle, acquired in S10. For example, using the presence probability Vₖ calculated in the previous processing cycle, and the detection probability P_{d} calculated in the current processing cycle, the presence probability calculation unit calculates (i) the probability that a target is present when no target is currently detected, and (ii) the probability updated based on the observed value when a target is currently detected.

Here, (i) corresponds to the presence probability of a target, taking into consideration the case where the target is present but is not detected. (ii) corresponds to the presence probability updated based on the observed value obtained when the target is present. The presence probability calculation unit calculates the presence probability Vₖ in the current processing cycle by adding together (i) and (ii). However the method of calculating the presence probability Vₖ is not particularly limited.

In that way, the presence probability Vₖ of a target is calculated in accordance with the reflection intensity and reflection position of the target. for example, the reflection intensity of reflected waves from distant objects is relatively weak. Hence, a distant object may or may not be detected in each processing cycle. Thus, if recognition of an object is performed by distinguishing between the object and floating matter on condition that the object is continuously detected for a prescribed period of time, then recognition of a distant object may become delayed. However with the present embodiment, even if a detected object ceases to be detected, the presence probability Vₖ of the object is maintained without being reset. Hence, distant objects can be quickly recognized.

Next, in S50, for each target, the recognition unit judges whether the presence probability Vₖ calculated in S40 is equal to or greater than a prescribed probability threshold. If the recognition unit judges that the presence probability Vₖ is equal to or greater than the probability threshold, the processing proceeds to S60, while if it is judged that the presence probability Vₖ is less than the probability threshold, the processing proceeds to S70.

In S60, a target whose presence probability Vₖ is equal to or greater than the probability threshold is recognized as representing an object, by the recognition unit.

In S70, a target whose presence probability Vₖ is less than the probability threshold fails to be recognized as representing an object, by the recognition unit.

### 1-3. Effects

The following effects are obtained with the first embodiment described above.

(1) A detection probability P_{d} corresponding to a reflection intensity is calculated. Then, from considerations that (i) a target may fail to be detected even though it is present, and (ii) a target may be erroneously detected even though it is not present, the presence probability Vₖ of a target is calculated using the detection probability P_{d}. If it is then found that the presence probability Vₖ is equal to or greater than a predetermined value, the pre-recognition target that is being tracked is recognized as a target representing an object. It is thereby made possible to recognize an object from a weak reflected signal, while suppressing erroneous recognition of noise as being an object.

(2) By calculating the detection probability P_{d} based on the observed value of reflection intensity, the accuracy of the presence probability Vₖ can be increased.

(3) Since thermal noise follows a Gaussian distribution, a weak reflected signal indicating an object can be extracted from the thermal noise by approximating the reflection intensity distribution to a Gaussian distribution, thereby enabling the object to be quickly recognized.

### 2. Second Embodiment

### 2-1. Differences from First Embodiment

Since the basic configuration of the second embodiment is the same as that of the first embodiment, only differences from the first embodiment are described in the following. Reference numerals which are the same as in the first embodiment indicate the same configurations as in the first embodiment, and refer to the preceding description.

In the second embodiment, target tracking processing (hereinafter referred to as RFS tracking) is performed using a state estimation filter based on random finite set theory (hereinafter referred to as RFS theory). State estimation filters based on RFS theory include the Probability Hypothesis Density (PHD) filter, the Cardinalized Probability Hypothesis Density (CPHD) filter, the Cardinality Balanced Multi-Bernoulli (CBMeMBer) filter, the Generalized Labeled Multi-Bernoulli (GLMB) filter, the Labeled Multi-Bernoulli (LMB) filter, the Poisson Multi-Bernoulli (PMB) filter, the Poisson Multi-Bernoulli Mixture (PMBM) filter, and the like.

### 2-2. Processing

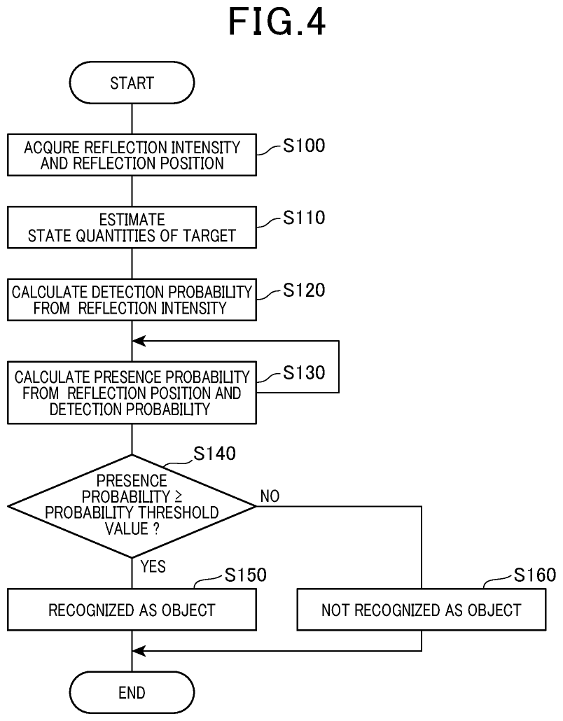

Next, object recognition processing executed by various functions of the processing device 20 according to the second embodiment will be described with reference to the flowchart of FIG. 4.

In S100-S120, the tracking unit and the detection probability calculation unit perform the same processing as in S10-S30, using RFS tracking.

In S130, the presence probability calculation unit calculates the presence probability Vₖ by RFS tracking, from the reflection position and the detection probability P_{d}. For example, the presence probability calculation unit calculates the presence probability Vₖ using a PHD filter. Specifically, the presence probability Vₖ is calculated based on the following equations (1) and (2). The presence probability Vₖ calculated here corresponds to the expected value of the number of objects per unit of area, that is, corresponds to the strength. The greater the value of the presence probability Vₖ, the higher is the probability that an object is present.

$$\begin{matrix}[ Equation 1 ] & \\ {v}_{k \vert k - 1} ( {x}_{k} \vert {z}_{1 : k - 1} ) = \int {p}_{s , k} ( {x}_{k - 1} ) φ ( {x}_{k} \vert {x}_{k - 1} ) {v}_{k - 1} ( {x}_{k - 1} \vert {z}_{1 : k - 1} ) dx + \int {β}_{k \vert k - 1} ( x \vert x - 1 ) {v}_{k - 1} ( {x}_{k - 1} \vert {z}_{1 : k - 1} ) + {r}_{k} & ( 1 )\end{matrix}$$

$$\begin{matrix}[ Equation 2 ] & \\ {v}_{k} ( {x}_{k} \vert {z}_{1 : k} ) = ( 1 - {p}_{d , k} ( x ) ) {v}_{k \vert k - 1} ( {x}_{k} \vert {z}_{1 : k - 1} ) + {\sum }_{z ∈ {z}_{x}} \frac{{p}_{d , k} ( x ) {g}_{k} ( z \vert x ) {v}_{k \vert k - 1} ( {x}_{k} \vert {z}_{1 : k - 1} )}{{k}_{k} ( z ) + \int {p}_{d , k} ( x ) {g}_{k} ( z \vert x ) {v}_{k \vert k - 1} ( {x}_{k} \vert {z}_{1 : k - 1} ) dx} & ( 2 )\end{matrix}$$

From the presence probability Vₖ₋₁ (xₖ₋₁ | z_{1:k-1}) obtained in the previous processing cycle, equation (1) calculates the predicted value V_{k|k-1} (xₖ₋₁ | z_{1:k-1}) of presence probability in the current processing cycle. x represents a state quantity, z represents an observable quantity, and k represents time. The first term on the right-hand side of equation (1) corresponds to a prediction of how the distribution of objects per unit area in the previous processing cycle is changed in the current processing cycle, and corresponds to the integral of survival probability x propagation function x previous presence probability. The survival probability is the probability that the target will not disappear. The second term on the right side of equation (1) corresponds to a branch from the distribution of objects per unit area in the previous processing cycle, and the third term on the right side of equation (1) corresponds the distribution of objects per unit area at time k.

Equation (2) calculates the presence probability Vₖ (xₖ | z_{1:k}) in the current processing cycle based on the prediction value Vₖ|ₖ₋₁ (xₖ | z_{1:k-1}) calculated by Equation (1) and the detection probability P_{d}.

The first term on the right side of equation (2) corresponds to (i) the expected value of the number of objects per unit area when no targets are detected in the current processing cycle. The second term on the right side of equation (2) corresponds to (ii) the expected value of the number of objects per unit area, when targets are detected. Kₖ (z) expresses noise.

Subsequently, in S140-S160, the recognition unit executes the same processing as in S50-S70.

### 2-3. Effects

The second embodiment described in detail above provides the effects (1) to (3) of the first embodiment described above, while the following effect is also obtained.

(4) By calculating the presence probability Vₖ using a RSS that is supported by theory, it is possible to increase the reliability of the presence probability Vₖ that is calculated according to the reflection intensity.

### 3. Third Embodiment

### 3-1. Differences from First Embodiment

Since the basic configuration of the third embodiment is the same as that of the first embodiment, only differences from the first embodiment are described in the following. Reference numerals which are the same as in the first embodiment indicate the same configurations as in the first embodiment, and refer to the previous description.

The third embodiment differs from the first embodiment in that the processing device 20 has the function of an area estimation unit. The area estimation unit estimates an occurrence area where occlusion occurs. The detection probability calculation unit corrects the detection probability in the estimated occurrence area.

### 3-2. Processing

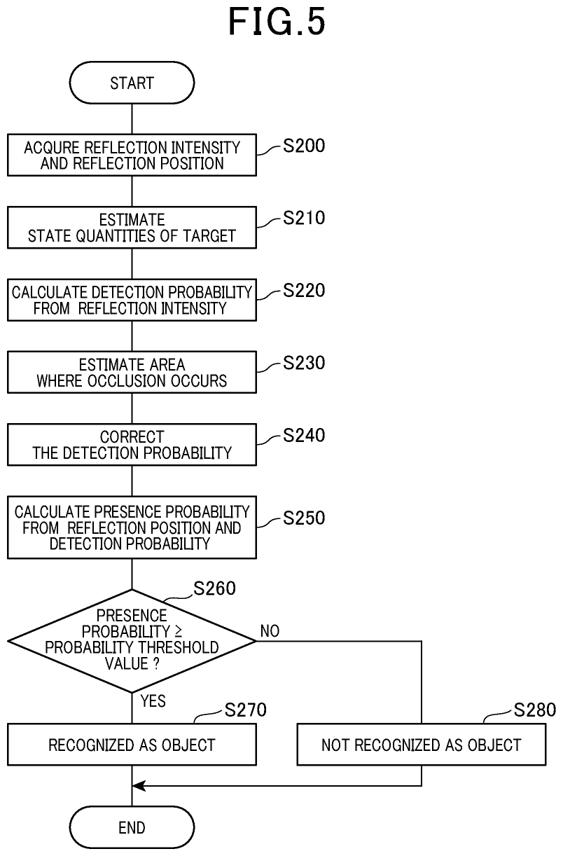

Next, object recognition processing executed by various functions of the processing device 20 according to the third embodiment will be described with reference to the flowchart of FIG. 5.

In S200-S220, the tracking unit and the detection probability calculation unit perform the same processing as in S10-S30.

In S230, the area estimation unit estimates an occurrence area where occlusion occurs. Specifically, the area estimation unit identifies a reflection position that is behind another reflection position among the plurality of reflection positions acquired in S200, and sets the area in which the identified reflection position is present as an occurrence area.

Next, in S240, of the detection probabilities calculated in S220, the detection probability calculation unit reduces the detection probability in the occurrence area estimated in S230.

Next, in S250 to S280, the presence probability calculation unit and the recognition unit execute the same processing as in S40 to S70.

### 3-3. Effects

With the third embodiment described in detail above, the effects (1) to (3) of the above-described first embodiment are obtained, while also the following effect is obtained.

(5) The accuracy of the detection probability P_{d} can be improved, by lowering the detection probability P_{d} in an occurrence area where occlusion occurs. As a result, the accuracy of the presence probability Vₖ can be improved.

### 4. Fourth Embodiment

### 4-1. Differences from Third Embodiment

Since the basic configuration of the fourth embodiment is the same as that of the third embodiment, only differences are described in the following. Reference numerals which are the same as in the third embodiment indicate the same configurations as in the third embodiment, and refer to the previous description.

In the third embodiment described above, the processing device 20 estimates an occurrence area where occlusion occurs based on reflection positions observed by the target sensor 10. The fourth embodiment differs from the third embodiment in that the processing device 20 estimates an occurrence area where occlusion occurs based on observation information from the environment sensor 40, which is different from the target sensor 10.

### 4-2. Processing

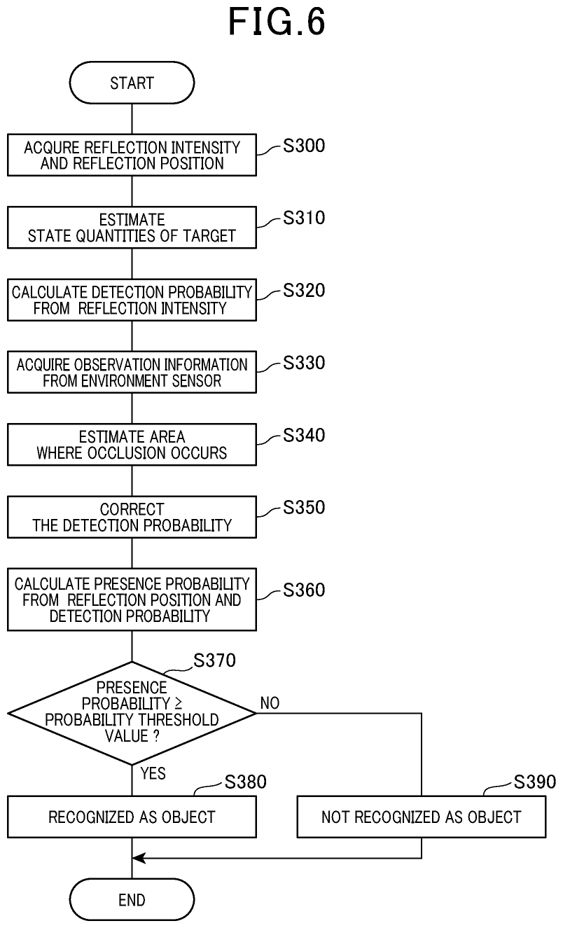

Next, object recognition processing executed by various functions of the processing device 20 according to the fourth embodiment will be described with reference to the flowchart of FIG. 6.

In S300-S320, the tracking unit and the detection probability calculation unit perform the same processing as in S200-S220.

In S330, the detection probability calculation unit acquires observation information that is observed by the environment sensor 40. The environment sensor 40 is a sensor that observes the surrounding environment of the target sensor 10. The environment sensor 40 is, for example, an vehicle-mounted camera that captures the environment in front of the automobile, with the observation information consisting of images captured by the vehicle-mounted camera.

In S340, the area estimation unit estimates an occurrence area where occlusion occurs based on the observation information acquired in S330. When the observation information consists of captured images, an area where a target is hidden behind another target in the images is estimated to be an occurrence area where occlusion occurs.

Subsequently, in S350 to S390, the detection probability calculation unit, presence probability calculation unit and recognition unit execute the same processing as in S240 to S280.

### 4-3. Effects

With the fourth embodiment described in detail above, the same effects as the effects (1) to (3) and (5) of the third embodiment described above are obtained.

### 5. Fifth Embodiment

### 5-1. Difference from First Embodiment

Since the basic configuration of the fifth embodiment is the same as that of the first embodiment, only the differences are described in the following. Reference numerals which are the same as in the first embodiment indicate the same configurations as in the first embodiment, and refer to the previous description.

The fifth embodiment differs from the first embodiment in that, with the fifth embodiment, the tracking unit calculates the difference between the observed value of reflection intensity and the state quantity of reflection intensity, and if the difference is equal to or greater than a difference threshold, the presence probability obtained in the preceding processing cycle is retained.

### 5-2. Processing

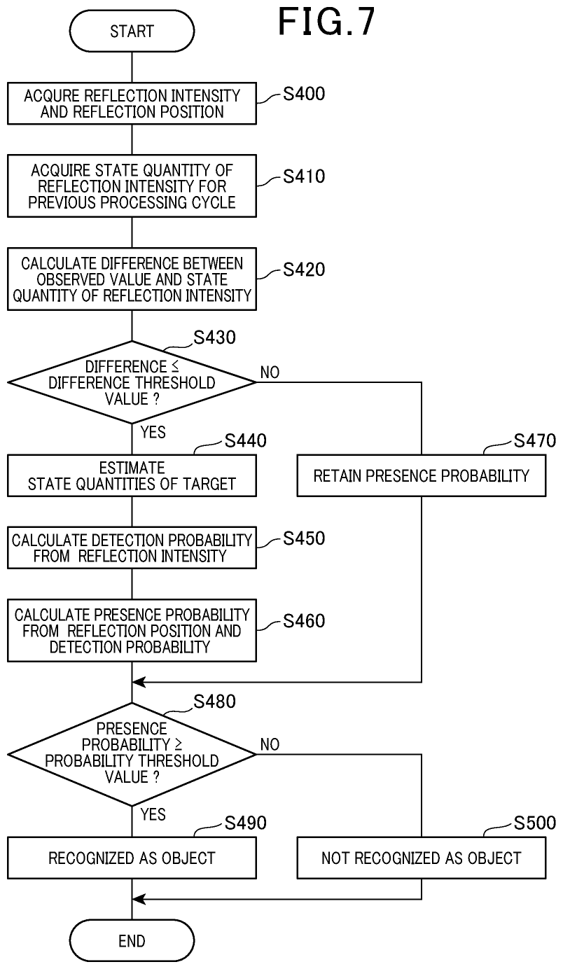

Next, object recognition processing executed by the processing device 20 according to the fifth embodiment will be described with reference to the flowchart of FIG. 7.

In S400, the tracking unit performs the same processing as in S10.

Next, in S410, the tracking unit acquires the state quantities of the reflection intensities of each of the targets estimated in the previous processing cycle.

Next, in S420, the tracking unit calculates, for each target, the difference between the observed value of reflection intensity acquired for the target in S400 and the state quantity of the reflection intensity obtained in the previous processing cycle which is most closely related to the observed value acquired in S400.

Next, in S430, the tracking unit determines, for each target, whether the difference calculated in S420 is equal to or less than a prescribed difference threshold. If the tracking unit determines in S430 that the difference is equal to or less than the difference threshold, the processing proceeds to S440. In S440-S460, the tracking unit, the detection probability calculation unit and the presence probability calculation unit execute the same processing as in S20-S40.

However if the tracking unit determines in S430 that the difference is greater than the difference threshold, the processing proceeds to S470. In S470, the presence probability calculation unit retains the presence probability Vₖ calculated in the previous processing cycle. That is, if the difference is greater than the difference threshold, the observed value of reflection intensity is not associated with the state quantity of reflection intensity, and the presence probability Vₖ is not calculated.

Subsequently, in S480-S500, the recognition unit executes the same processing as in S50-S70.

### 5-3. Effects

With the fifth embodiment described in detail above, the effects (1) to (3) of the first embodiment described above are obtained, while also the following effects are obtained.

(6) By not associating the observed value and state quantity when the difference is greater than the difference threshold, association of an observed value and state quantity of a different target, and calculation of the detection probability P_{d}, can be suppressed. As a result, the accuracy of both the detection probability P_{d} and of the presence probability Vₖ can be enhanced.

### 6. Sixth Embodiment

### 6-1. Differences from First Embodiment

Since the basic configuration of the sixth embodiment is the same as that of the first embodiment, only the differences are described in the following. Reference numerals which are the same as in the first embodiment indicate the same configurations as in the first embodiment, and refer to the previous description.

The sixth embodiment differs from the first embodiment in that, with the sixth embodiment the processing device 20 acquires environmental information from an environment sensor 40, and corrects the detection probability if the environmental information includes bad environment information.

### 6-2. Processing

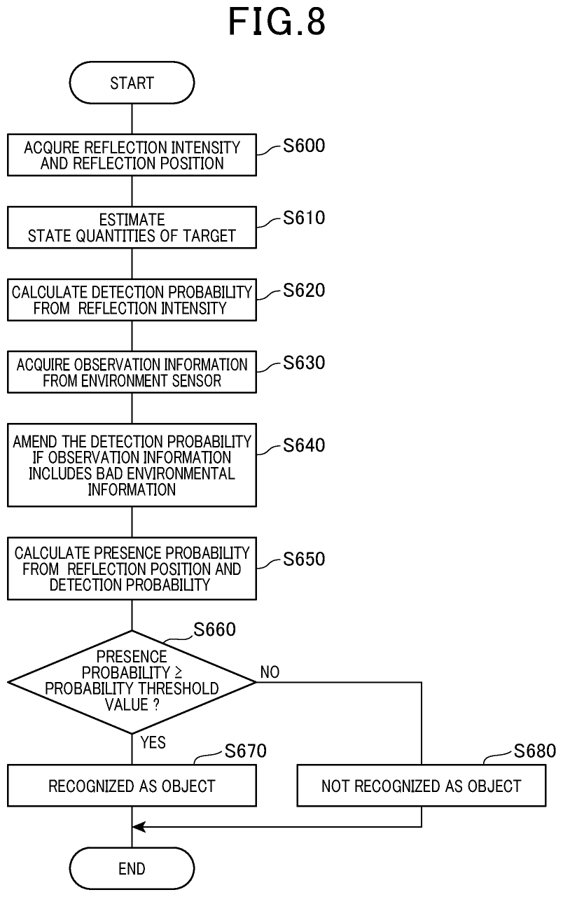

Next, object recognition processing executed by the processing device 20 according to the sixth embodiment will be described with reference to the flowchart of FIG. 8.

In S600-S620, the tracking unit and the detection probability calculation unit perform the same processing as in S10-S30.

In S630, the detection probability calculation unit acquires observation information observed by the environment sensor 40. The environment sensor 40 observes the surrounding environment of the target sensor 10. The environment sensor 40 is, for example, an vehicle-mounted camera that captures the environment in front of the automobile, with the observation information consisting of images captured by the vehicle-mounted camera.

Next, in S640, for each target calculated in S620, the detection probability calculation unit reduces the detection probability if the observation information acquired for the target in S630 includes bad environmental information. Here, “bad environmental information” signifies environmental information obtained when the detection performance of the target sensor 10 is lowered, such as information obtained during rainy weather.

Next, in S650 to S680, the presence probability calculation unit and the recognition unit execute the same processes as in S40 to S70.

### 6-3. Effects

With the sixth embodiment described in detail above, the effects (1) to (3) of the first embodiment described above are obtained, and the following effects are also obtained.

(7) When the surrounding environment of the target sensor 10 is such as to cause deterioration of the target detection conditions, the accuracy of the detection probability P_{d} can be improved by lowering the detection probability P_{d}. The accuracy of the presence probability Vₖ can thereby be improved.

### 7. Other Embodiments

Although embodiments of the present disclosure have been described above, the present disclosure is not limited to these embodiments, and various changes can be made.
(a) A plurality of functions possessed by one component in the above embodiments may be realized by a plurality of components, or a function possessed by one component may be realized by a plurality of components. Furthermore, a plurality of functions possessed by a plurality of components may be realized by a single component, or a function realized by a plurality of components may be realized by a single component. Furthermore, part of the configurations of the above embodiments may be omitted. Moreover, at least part of the configuration of one of the above embodiments may be added to or replaced in the configuration of another of the above embodiments.
(b) In addition to the object recognition device described above, the present disclosure can also be implemented in various forms, such as a system having the object recognition device as a component part, a program for causing a computer to function as the object recognition device, a non-transitory tangible storage medium such as a semiconductor memory in which the program is recorded, object recognition methods, etc.

What is claimed is:

1. An object recognition device comprising:
a target sensor configured to transmit a probe wave to a surrounding area and receive a reflected wave produced by reflection of the probe wave from a target, and, based on the received reflected wave, periodically and repeatedly acquire an observed value of reflection position of the target and an observed value of reflection intensity;
a tracking unit configured to sequentially estimate a state quantity of the target in the current process cycle based on (i) the observed value of the reflection position obtained by the target sensor and (ii) a state quantity of the target which includes at least the reflection position and is estimated in the previous processing cycle, and track the target;
a detection probability calculation unit configured to calculate a detection probability of the target in the current process cycle based on the observed value of the reflection intensity acquired in the previous processing cycle or on the reflection intensity included in the state quantity of the target, wherein the stronger the reflection intensity, the higher is made the calculated detection probability;
a presence probability calculation unit configured to calculate the presence probability of the target with respect to the observed value of the reflection position in the current processing cycle, using the detection probability calculated by the detection probability calculation unit; and
a recognition unit configured to recognize a target being tracked by the tracking unit as a target representing an object, in response to the presence probability calculated by the presence probability calculation unit being greater than or equal to a predetermined value.

2. The object recognition device according to claim 1, wherein
the state quantity of the target includes the reflection position and the reflection intensity;
the tracking unit is configured to sequentially estimate the state quantity of the target in the current processing cycle based on (i) the observed value of the reflection position and the observed value of the reflection intensity, and (ii) the state quantity of the target estimated in the previous processing cycle; and
the detection probability calculation unit is configured to calculate the detection probability based on the observed value of the reflection intensity.

3. The object recognition device according to claim 1, wherein the presence probability calculation unit is configured to calculate the presence probability by using a random finite set.

4. The object recognition device according to claim 1, wherein the detection probability calculation unit is configured to approximate a distribution of the reflection intensity to a Gaussian distribution, and to calculate the detection probability based on a proportion of the approximated distribution of the reflection intensity that exceeds an intensity threshold.

5. The object recognition device according to claim 1, further comprising an area estimation unit configured to estimate an occurrence area where occlusion occurs,
wherein the detection probability calculation unit is configured to reduce the detection probability in the occurrence area estimated by the area estimation unit.

6. The object recognition device according to claim 2, wherein
the tracking unit is configured such that if a first difference exceeds a threshold value, the observed value of the reflection position and the observed value of the reflection intensity are not associated with the state quantity of the target estimated in the previous processing cycle, the first difference being a difference between the observed value of the reflection intensity and the reflection intensity included in the state quantity of the target.

7. The object recognition device according to claim 1, wherein the detection probability calculation unit is configured to reduce the detection probability when bad environment information is acquired from an environment sensor.

8. The object recognition device according to claim 1, wherein the object recognition device is mounted to an automobile.
